(19) United States
(12) Patent Application Publication
(10) Pub. No.: US 2026/0142735 A1
(43) Pub. Date: May 21, 2026

(54) METHOD AND SYSTEM FOR INTERFERENCE MAP GENERATION

(71) Applicant: Verizon Patent and Licensing Inc., Basking Ridge, NJ (US)

(72) Inventor: Vikramjeet Singh, Irvine, TX (US)

(21) Appl. No.: 18/952,028

(22) Filed: Nov. 19, 2024

(51) Int. Cl. H04B 17/345; H04W 72/541

(52) U.S. Cl. CPC H04B 17/345; H04W 72/541

(57) ABSTRACT

One or more computing devices, systems, and/or methods for determining interference metrics associated with a view and/or using the interference metrics to generate an interference map associated with the view are provided. In an example, an image of a view may be received. An antenna may be used to determine one or more interference metrics associated with one or more regions of the view. An interference map associated with the view may be generated based upon the image and the one or more interference metrics. One or more corrective actions associated with a wireless communication site may be performed based upon the interference map.

### BACKGROUND

Interference in telecommunication services may cause issues including degraded quality, loss of communication, noise, distortion, dropped calls, slow data transmission, reduced signal strength, etc. As telecommunication networks expand and more devices are interconnected, managing interference becomes increasingly important for maintaining service quality.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for determining interference metrics associated with a view and/or using the interference metrics to generate an interference map associated with the view, according to some embodiments.

FIG. 1B illustrates an example representation of an image of a view captured using a camera, according to some embodiments.

FIG. 1C illustrates an example representation of a grid overlaying an image of a view captured using a camera, according to some embodiments.

FIG. 1D is a diagram illustrating use of a low risk identification model configured to identify a set of low risk regions based upon an image, according to some embodiments.

FIG. 1E illustrates an example representation of low risk regions associated with an image, according to some embodiments.

FIG. 1F illustrates an example representation of an interference map, according to some embodiments.

FIG. 1G is a diagram illustrating calibration of a system for determining interference metrics associated with a view and/or using the interference metrics to generate an interference map associated with the view, according to some embodiments.

FIG. 1H illustrates an example representation of an antenna for determining interference metrics associated with a view, according to some embodiments, according to some embodiments.

FIG. 2 is a flow chart illustrating an example method for determining interference metrics associated with a view and/or using the interference metrics to generate an interference map associated with the view, according to some embodiments.

FIG. 3 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

Interference may include spurious emissions and/or unwanted radio signals that may potentially negatively impact a wireless system. Interference may originate from inside the wireless system or can be generated externally to the wireless system. Interference may be considered to be external interference if a source of the interference is not part of the wireless system. External interference may be associated with external objects (e.g., metallic clamps, rusted bolts, heating, ventilation, and air conditioning (HVAC) units, parapet walls, metallic bird spikes, etc.) that may be in the vicinity of a wireless communication site (e.g., a base station) of the wireless system. Internal interference may be associated with internal network issues associated with the wireless system (e.g., installation quality issues, bad cable and/or connectors, faulty radio, etc.). Sources of interference (e.g., internal interference and/or external interference) may include at least one of metal snap-in hangers, galvanic mismatches, insufficiently tightened nuts, grounding wire touching other metal parts, metal strap, metal sign, hose clamp, rusted metal, cable clamped against metal member, cable hanger, interference producing hardware (left over from a previous site configuration, for example), consumer electronics (e.g., at least one of cordless phones, baby monitors, etc.) that transmit radio frequencies within an operating band of the wireless system etc.

Interference (e.g., internal interference and/or external interference) may negatively impact telecommunication service provided by a wireless communication site (e.g., a base station) to one or more users. For example, the interference may cause service issues including at least one of degraded quality, loss of communication, noise, distortion, dropped calls, slow data transmission, reduced signal strength, etc. Some systems may attempt to find sources of the interference by tasking engineers (e.g., highly-skilled engineers with high training cost) with manually performing a time consuming inspection of an area (e.g., a relatively large area) around the wireless communication site (e.g., the engineers may be tasked with manually touching objects in the area with an interference detector tool), which requires a significant amount of skill to perform correctly, as well as a significant amount of time, a significant amount of spend and/or relatively low productivity.

One or more systems and/or techniques are provided herein for automatically determining interference, especially passive intermodulation (PIM) interference, metrics associated with a view and/or using the interference metrics to generate an interference map (e.g., a heat map) associated with the view. For example, an image of a view may be captured using a camera. An antenna may be used to automatically determine one or more interference metrics associated with one or more regions of the view. An interference map associated with the view may be automatically generated based upon the image and the one or more interference metrics. The interference map may allow a viewer to visualize interference metrics associated with regions of the view and/or to quickly understand which regions have potential interference issues that warrant attention and/or which regions do not warrant attention.

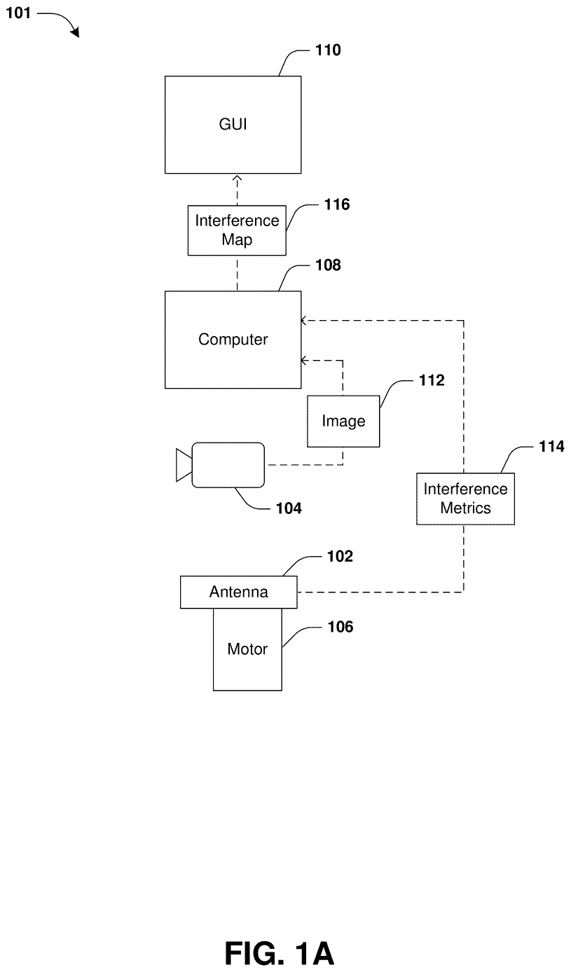

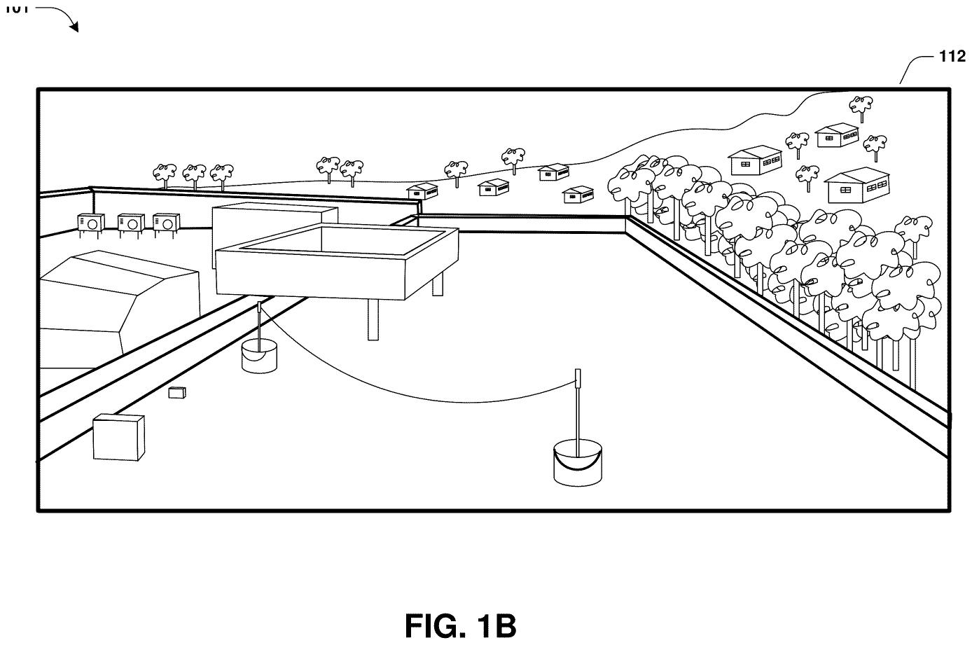

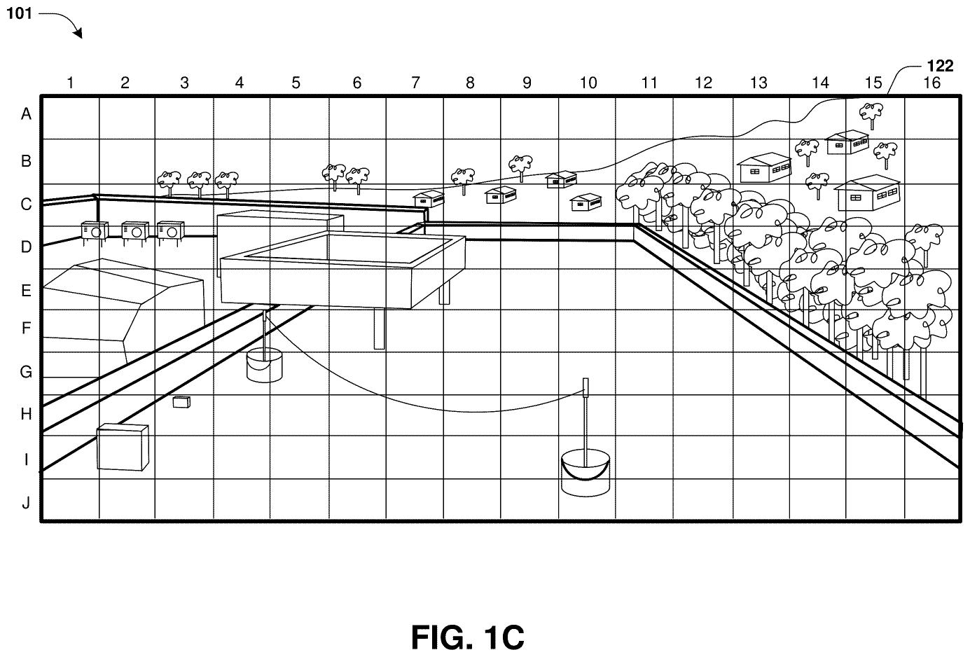

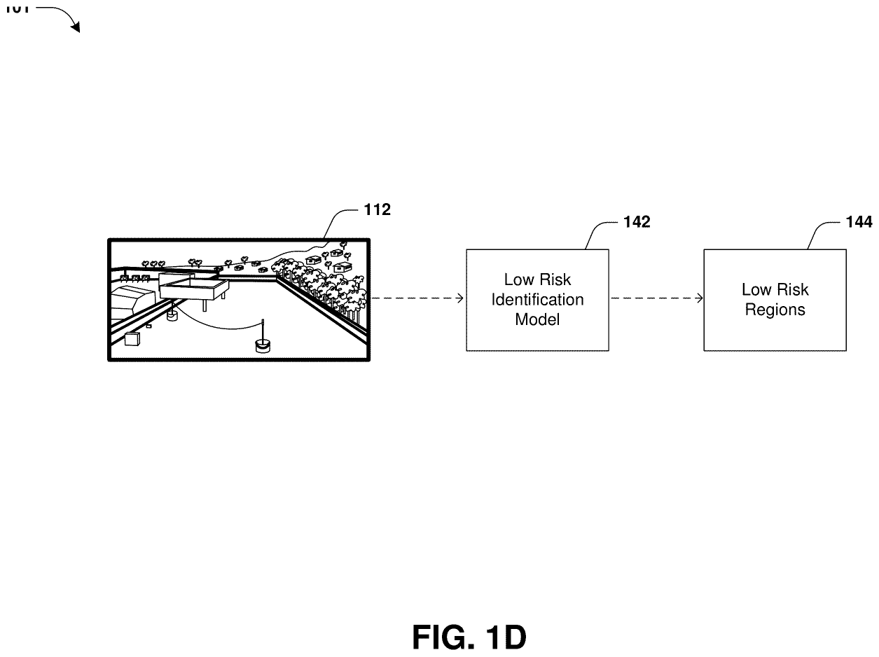

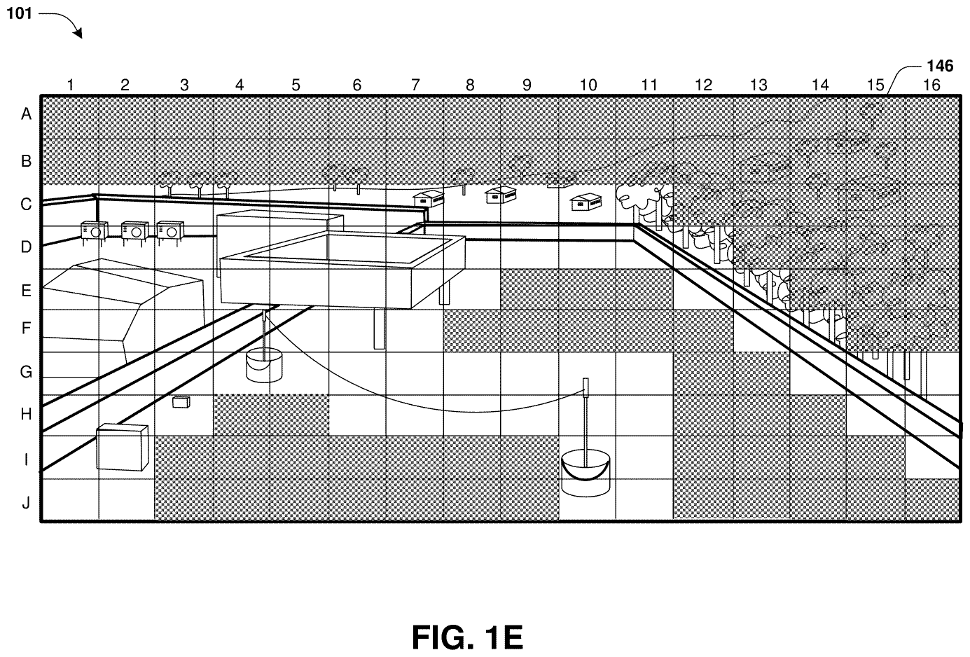

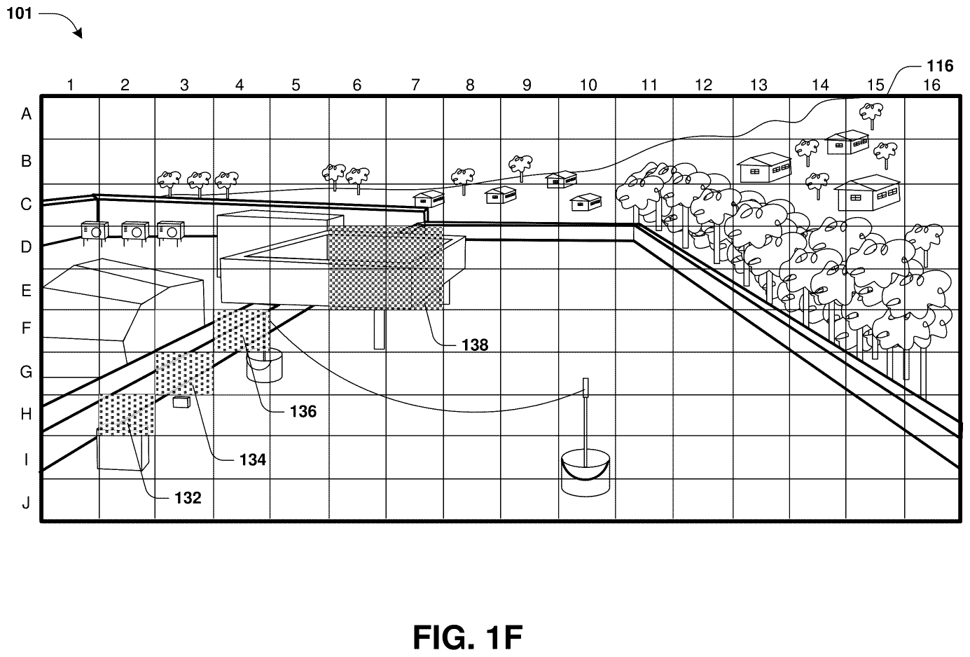

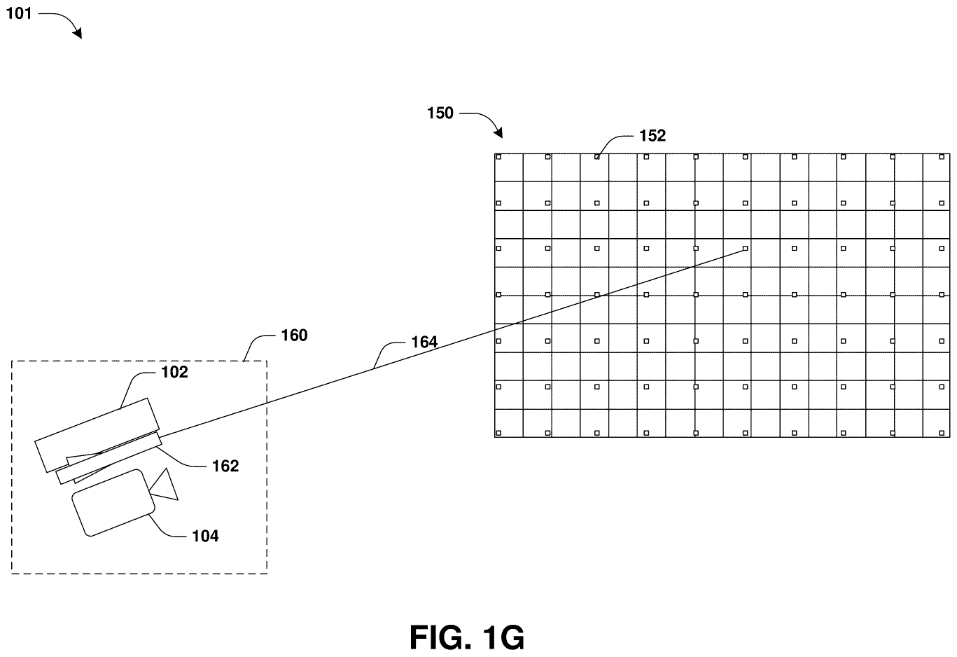

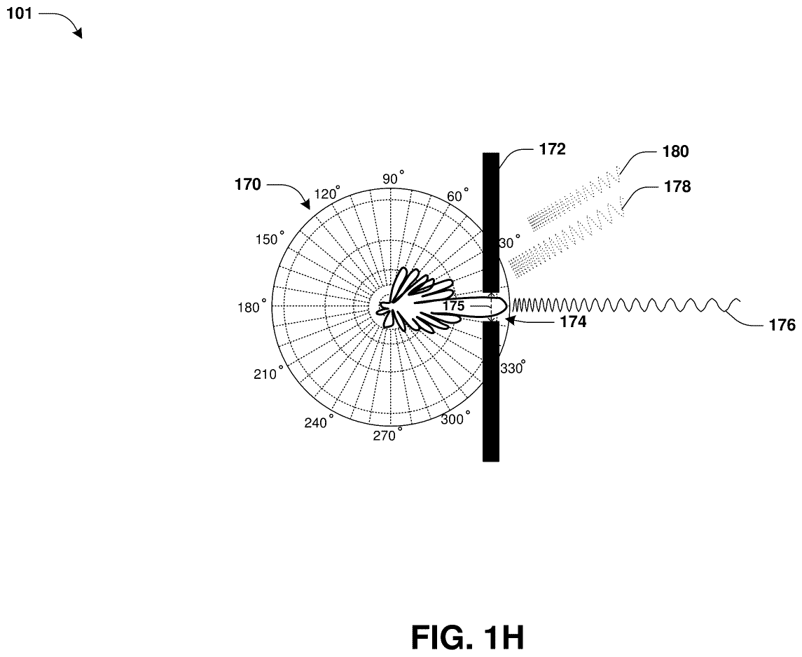

FIGS. 1A-1H illustrate examples of a system 101 for determining interference metrics associated with a view and/or using the interference metrics to generate an interference map associated with the view. The system 101 may implement an antenna eye spectrum analyzer for visualizing interference metrics associated with various regions associated with an image. FIG. 1A illustrates one or more components of the system 101 interacting to generate an interference map 116, in accordance with some embodiments. In some examples, the system 101 comprises an antenna 102, a camera 104, a computer 108, a motor 106, and/or a graphical user interface (GUI) 110. The camera 104 may be configured to capture an image 112 of a view. The antenna may be configured to determine a set of interference metrics 114 (e.g., a set of one or more interference metrics) associated with a set of regions (e.g., a set of one or more regions) of the view. The computer 108 may be configured to generate the interference map 116 associated with the view based upon the image 112 and the set of interference metrics 114.

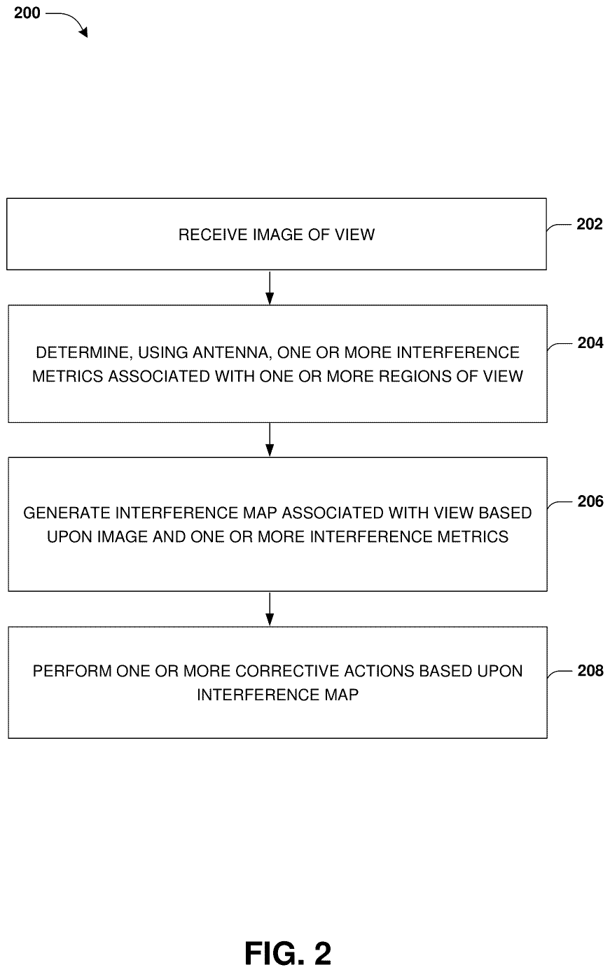

An embodiment of determining interference metrics associated with a view and/or using the interference metrics to generate an interference map associated with the view is illustrated by an exemplary method 200 of FIG. 2, and is further described in conjunction with the system 101 of FIGS. 1A-1H. At 202, the image 112 of the view may be received. In an example in which the camera 104 captures the image 112, the image 112 may be received by the computer 108 from the camera 104. In some examples, the camera 104 may capture the image 112 in response to receiving a selection of an image capture button. For example, an interference agent may capture the image 112 using the camera 104. Alternatively and/or additionally, the camera 104 may capture the image 112 automatically. Embodiments are contemplated in which the image 112 is received from (and/or captured by) a source different than the camera 104.

FIG. 1B illustrates an example representation of the image 112, in accordance with some embodiments. In some examples, the view depicted by the image 112 includes a rooftop of a building and/or a surrounding environment (e.g., landscape, trees and/or buildings surrounding the structure). In some examples, a set of networking components (e.g., a set of one or more networking components) of a telecommunication service provider may be positioned in the building, on the rooftop of the building, or within a threshold distance of the building.

The set of networking components may include a first wireless communication site comprising at least one of an antenna branch, a transmission and/or reception point (TRP), a base station, a cell tower, a radio transmitter and/or transceiver (e.g., a radio station), etc. For example, the set of networking components (e.g., the first wireless communication site) may be used to transmit and/or receive RF signals (e.g., uplink signals and/or downlink signals) to and/or from one or more devices comprising at least one of a user equipment (UE) (e.g., at least one of a phone, a smartphone, a tablet, a laptop, a computer, a wearable device, a smart device, any other type of computing device, hardware, etc.), a second wireless communication site, a second antenna branch, a second TRP, a second base station, a second cell tower, a radio receiver and/or transceiver, etc.

Interference conditions associated with the rooftop and/or the surrounding environment may be monitored (e.g., periodically monitored using the techniques provided herein) to check if there is a source of interference (at the rooftop and/or the surrounding environment, for example) that may potentially have (i) a negative impact on service performance of the set of networking components (e.g., the first wireless communication site), (ii) a negative impact on communication (e.g., wireless communication and/or wired communication) between the set of networking components and the one or more devices, and/or (iii) a negative impact on telecommunication service (e.g., internet service, cellular service, etc.) provided by the set of networking components to one or more UEs (e.g., a subscriber of the telecommunication service provider).

Alternatively and/or additionally, in response to identifying a network performance issue associated with the set of networking components, an interference condition check including (i) capturing the image 112, (ii) determining the set of interference metrics 114 and/or (iii) generating the interference map 116 may be triggered. For example, in response to identifying the network performance issue, the interference agent may be tasked with troubleshooting the network performance issue by using the system 101 to generate one or more interference maps (including the interference map 116) associated with one or more areas (e.g., areas within a vicinity of the set of networking components with the network performance issue) that could potentially have sources of interference associated with causing the network performance issue.

The network performance issue may comprise at least one of (i) anomalous behavior by the set of networking components (e.g., anomalous behavior by the first wireless communication site), (ii) decreased signal quality of signals transmitted by the set of networking components, (iii) decreased signal to noise ratio (SNR) associated with transmissions and/or receptions by the set of networking components, (iv) decreased data throughput associated with transmissions and/or receptions by the set of networking components, (v) increased error rates associated with transmissions and/or receptions by the set of networking components, (vi) creation of coverage holes where UEs experience poor and/or zero network coverage, (vii) increased latency associated with transmissions and/or receptions by the set of networking components, etc.

At 204 of FIG. 2, the antenna 102 may be used to determine the set of interference metrics 114 associated with the set of regions of the view. In some examples, the set of interference metrics 114 (determined using the antenna 102) may comprise an interference metric associated with each region of one, some and/or all of the set of regions. For example, the set of interference metrics 114 may comprise a first interference metric associated with a first region (of the set of regions) of the view, a second interference metric associated with a second region (of the set of regions) of the view, etc.

In some examples, the motor 106 is coupled to the antenna 102 and/or is configured to control a position of the antenna 102. In some embodiments, the motor 106 is configured to move the antenna 102 vertically and/or horizontally. In some examples, the motor 106 comprises a stepper motor and/or a different type of motor. In some examples, the motor 106 comprises a robotic arm. The motor 106 may be configured to move the antenna 102 between a set of target positions associated with the set of regions. For example, each target position of the set of target positions may be associated with performing a radio frequency (RF) signal reading associated with one or more regions of the set of regions. For example, while the antenna 102 is positioned to have the target position associated with the one or more regions, the antenna 102 may be used to perform one or more RF signal readings associated with the one or more regions to determine one or more interference metrics (associated with the one or more regions) to be included in the set of interference metrics 114 (e.g., the one or more interference metrics associated with the one or more regions may be derived from one or more measurements performed via the one or more RF signal readings).

In an example, the antenna 102 may be positioned (by the motor 106, for example) at a first target position of the set of target positions. The first target position may be associated with performing an RF signal reading associated with the first region of the set of regions. While the antenna 102 is in the first target position, the antenna 102 performs a first RF signal reading to determine the first interference metric associated with the first region. The first RF signal reading may comprise (i) monitoring for a first RF signal (e.g., a spectrum analyzer signal) associated with the first region (e.g., the first RF signal may be emitted from the first region), (ii) sensing and/or measuring the first RF signal to determine one or more RF parameters associated with the first RF signal, and/or (iii) determining the first interference metric associated with the first region based upon the one or more RF parameters associated with the first RF signal. In an example, the one or more RF parameters used to determine the first interference metric may comprise (i) a signal level associated with the first RF signal, (ii) a frequency band associated with the first RF signal, and/or (iii) a measure (e.g., at least one of quantity, rate, amplitude, etc.) of spikes associated with the first RF signal (e.g., spikes present in the first RF signal may be representative of passive intermodulation (PIM) interference). In some examples, the first interference metric may be a function of the measure of spikes in the first RF signal, wherein a greater value of the measure of spikes may correspond to a greater value of the first interference metric. For example, one or more operations (e.g., mathematical operations) may be performed using the signal level, the frequency band and/or the measure of spikes associated with the first RF signal to determine the first interference metric.

In response to performing the first RF signal reading associated with the first region (and/or determining the first interference metric based upon the first RF signal reading), the motor 106 may move the antenna 102 from the first target position to a second target position of the set of target positions. The second target position may be associated with performing an RF signal reading associated with the second region of the set of regions. While the antenna 102 is in the second target position, the antenna 102 performs a second RF signal reading to determine the second interference metric associated with the second region. In response to performing the second RF signal reading (and/or determining the second interference metric based upon the second RF signal reading), the motor 106 may move the antenna 102 from the second target position to a third target position (of the set of target positions) associated with a third region of the set of regions. In some examples, iterations of (i) moving the antenna 102 using the motor 106 to a predefined target position of the set of target positions and/or (ii) performing an RF signal reading while the antenna 102 is positioned at the predefined target position are performed until interference metrics (e.g., the set of interference metrics 114) are determined for each region of one, some and/or all of the set of regions.

In some examples, the camera 104 remains stationary while the motor 106 is used move the antenna 102 between the set of target positions associated with the set of regions. Embodiments are contemplated in which the camera 104 is moved using the motor 106 (and/or a second motor). In some examples, the motor 106 (and/or the second motor) is coupled to the camera 104 and/or is configured to control a position of the camera 104. In some embodiments, the motor 106 (and/or the second motor) is configured to move the camera 104 vertically and/or horizontally. In some examples, the image 112 comprises a panoramic image generated by (i) capturing a plurality of images associated with a plurality of camera positions, and/or (ii) combining the plurality of images to generate the panoramic image. In an example, while the camera 104 is in a first camera position of the plurality of camera positions, the camera 104 may capture a first image of the plurality of images. In response to capturing the first image, the motor 106 (and/or the second motor) may move the camera 104 from the first camera position to a second camera position of the plurality of camera positions. While the camera 104 is in the second camera position, the camera 104 may capture a second image of the plurality of images. In some examples, iterations of (i) moving the camera 104 using the motor 106 (and/or the second motor) to a predefined camera position of the plurality of camera positions and/or (ii) capturing an image while the camera 104 is positioned at the predefined camera position are performed until a threshold quantity of images are captured for use in generating the panoramic image.

At 206 of FIG. 2, the interference map 116 associated with the view may be generated (by the computer 108, for example) based upon the image 112 and/or the set of interference metrics 114. The interference map 116 may be indicative of interference conditions associated with the view depicted by the image 112. For example, for each region of one, some and/or all of the set of regions, the interference map 116 may be indicative of an interference metric associated with the region and/or whether the interference metric meets a threshold. A first section of the interference map 116 may be generated based upon (i) the first interference metric associated with the first region of the view and/or (ii) a first section, of the image 112, corresponding to the first region. A second section of the interference map 116 may be generated based upon (i) the second interference metric associated with the second region of the view and/or (ii) a second section, of the image 112, corresponding to the second region.

In some examples, the interference map 116 may be generated to be indicative of interference metrics associated with the set of regions in a visual manner (e.g., in a color-coded manner using various colors). For example, the computer 108 may (i) determine a first visual attribute (e.g., a first color, a first pattern and/or other visual attribute) associated with the first region based upon the first interference metric and/or (ii) overlay a first object having the determined first visual attribute onto the first section of the image 112 to generate the first section of the interference map 116. For example, the first visual attribute of the first object of the interference map 116 may be determined based upon (i) the signal level associated with the first RF signal, (ii) the frequency band associated with the first RF signal, and/or (iii) the measure of spikes associated with the first RF signal.

The computer 108 may (i) determine a second visual attribute (e.g., a second color, a second pattern and/or other visual attribute) associated with the second region based upon the second interference metric and/or (ii) overlay a second object having the determined second visual attribute onto the second section of the image 112 to generate the second section of the interference map 116. The second visual attribute of the second object of the interference map 116 may be determined based upon (i) a second signal level associated with a second RF signal sensed and/or measured via the second RF signal reading, (ii) a second frequency band associated with the second RF signal, and/or (iii) a second measure of spikes associated with the second RF signal.

The first visual attribute may be different than the second visual attribute due, at least in part, to (i) the first interference metric being different than the second interference metric, (ii) the first signal level being different than the second signal level, (iii) the first frequency band being different than the second frequency band, and/or (iv) the first measure of spikes being different than the second measure of spikes. For example, the first color may be different (e.g., different shade and/or color) than the second color (and/or the first pattern may be different than the second pattern) when the first interference metric is different than the second interference metric.

In some examples, the aforementioned techniques may be further used by the computer 108 to determine visual attributes for one or more other objects to be overlaid onto other sections of the image 112. The interference map 116 may then be generated using the respective visual attributes determined for the objects.

In some examples, a grid may be applied to the image 112 to identify and/or distinguish regions of the set of regions. FIG. 1C illustrates a representation 122 of an example of the grid overlaid onto the image 112 to separate the image 112 into the set of regions. For example, the set of regions may be arranged across a set of columns 1-N and/or a set of rows A-Z. For example, row A may include regions A-1, A-2, A-3, etc. Row B may include regions B-1, B-2, B-3, etc. Column 1 may include regions A-1, B-1, C-1, etc. Column 2 may include regions A-2, B-2, C-2, etc. Although 16 columns and 10 rows are shown in FIG. 1C, other numbers of columns associated with the set of regions and/or other numbers of rows associated with the set of regions are within the scope of the present disclosure. A region of the set of regions may be rectangle-shaped. Other shapes associated with the set of regions (other than rectangle) are within the scope of the present disclosure (e.g., the set of regions may include at least one of a circle-shaped region, an oval-shaped region, a hexagon-shaped region, a pentagon-shaped region, etc.).

The antenna 102 may perform RF signal readings from top to bottom and/or left to right relative to the grid to determine the set of interference metrics 114 associated with the set of regions. In an example, the antenna 102 may at least one of (i) perform one or more RF signal readings for one or more regions of row A from left to right (e.g., starting with region A-1 and/or ending with region A-16) to determine interference metrics for row A to include in the set of interference metrics 114, (ii) subsequently, perform one or more RF signal readings for one or more regions of row B from left to right (e.g., starting with region B-1 and/or ending with region B-16) to determine interference metrics for row B to include in the set of interference metrics 114, (iii) subsequently, perform one or more RF signal readings for one or more regions of row C from left to right (e.g., starting with region C-1 and/or ending with region C-16) to determine interference metrics for row C to include in the set of interference metrics 114, etc. Embodiments are contemplated in which the RF signal readings are performed according to a different order (such as bottom to top and/or right to left relative to the grid).

In some examples, the system 101 comprises a low risk identification model 142 configured to identify a set of low risk regions 144 (e.g., a set of one or more regions) based upon the image 112, such as shown in FIG. 1D. In some examples, the set of low risk regions 144 may comprise regions determined by the low risk identification model 142 to be associated with a low likelihood (e.g., a likelihood that is less than a threshold likelihood) of causing an interference issue. In some examples, the low risk identification model 142 is run by and/or implemented on the computer 108 (and/or a different computer that may be connected to the computer 108 through a network and/or the Internet).

In some examples, the low risk identification model 142 is trained using training information comprising (i) a plurality of images of views, and/or (ii) labeled information (e.g., ground truth information) indicative of interference metrics associated with the plurality of images (e.g., the labeled information may be indicative of interference maps generated using one or more of the techniques provided herein). The low risk identification model 142 may learn, from the training information, to identify parts of an image that are associated with a low (and/or near-zero) likelihood of being associated with an interference issue.

FIG. 1E illustrates an example representation 146 showing the image 112 with the set of low risk regions 144 shaded darker than other regions associated with the image 112. The set of low risk regions 144 may comprise a portion of the surrounding environment depicted in the image 112 and/or a portion of the rooftop depicted in the image 112. In some examples, the antenna 102 may be used to perform interference readings for the regions that are not darkened in the example representation 146 (e.g., regions with rails, wires, metal objects, machinery, structural items, etc.). Alternatively and/or additionally, the antenna 102 may skip interference readings for the set of low risk regions 144 (e.g., the regions that are darkened in the example representation 146). For example, the set of low risk regions 144 are skipped by the antenna 102 and/or the motor 106 when determining the set of interference metrics 114. Thus, the system 101 may save energy and/or time by not performing interference readings for the set of low risk regions 144.

FIG. 1F illustrates an example of the interference map 116. In some examples, the interference map 116 may comprise a set of objects (e.g., a set of one or more objects) overlaid onto one or more sections of the image 112. For example, the computer 108 may augment the image 112 (by supplementing the image 112 with the set of objects, for example) to generate the interference map 116. In some examples, one, some and/or all objects of the set of objects are transparent to provide visibility of one, some and/or all of the one or more sections of the image 112. In some examples, a color, a pattern, and/or other attribute of an object of the set of objects is configured based upon an interference metric of the set of interference metrics 114.

The set of objects may comprise an object 132 overlaid onto a section, of the image 112, corresponding to region H-2 of the set of regions. A color, a pattern, and/or other attribute of the object 132 may be configured based upon an interference metric, of the set of interference metrics 114, associated with the region H-2.

The set of objects may comprise an object 134 overlaid onto a section, of the image 112, corresponding to region G-3 of the set of regions. A color, a pattern, and/or other attribute of the object 134 may be configured based upon an interference metric, of the set of interference metrics 114, associated with the region G-3.

The set of objects may comprise an object 136 overlaid onto a section, of the image 112, corresponding to region F-4 of the set of regions. A color, a pattern, and/or other attribute of the object 136 may be configured based upon an interference metric, of the set of interference metrics 114, associated with the region F-4.

The set of objects may comprise an object 138 overlaid onto a section, of the image 112, corresponding to regions D-6, D-7, E-6 and E-7 of the set of regions. A color, a pattern, and/or other attribute of the object 138 may be configured based upon interference metrics, of the set of interference metrics 114, associated with the regions D-6, D-7, E-6 and E-7.

In some examples, the computer 108 may (i) compare interference metrics of the set of interference metrics 114 with a first threshold interference metric to identify a first subset of interference metrics, of the set of interference metrics 114, that do not meet the first threshold interference metric (e.g., each interference metric of the first subset of interference metrics does not exceed the first threshold interference metric), and/or (ii) identify a first subset of regions, of the set of regions, that are associated with the first subset of interference metrics (that do not meet the first threshold interference metric). In some examples, the first threshold interference metric corresponds to a minimum interference metric that warrants attention. In some examples, sections of the image 112 that correspond to the first subset of regions are unchanged by the computer 108 to generate the interference map 116. In an example in FIG. 1F, the first subset of regions (that are associated with interference metrics that do not meet the first threshold interference metric) may include at least one of row A, row B, row C, some regions of row D, etc. The interference map 116 may allow a viewer to quickly understand which regions have potential interference issues that warrant attention (e.g., regions that are covered by objects 132, 134, 136 and/or 138) and which regions are associated with interference metrics that do not warrant attention.

In some examples, the computer 108 determines a color, pattern and/or other attribute of an object of the set of objects based upon an interference representation profile. The interference representation profile may be indicative of a plurality of interference representational modes and/or a plurality of interference metric ranges. The plurality of interference representational modes may be indicative of at least one of a first interference representational mode (e.g., the first visual attribute such as the first color, the first pattern, and/or other visual attribute) associated with a first range of interference metrics, a second interference representational mode (e.g., the second visual attribute such as the second color, the second pattern, and/or other visual attribute) associated with a second range of interference metrics, etc.

In an example, the objects 132, 134 and 136 may be generated based upon the first interference representational mode (e.g., the objects 132, 134 and 136 may be generated to have the first visual attribute indicated by the first interference representational mode) in response to determining that each of the interference metrics associated with the regions H-2, G-3 and F-4 is within the first range of interference metrics. Alternatively and/or additionally, the object 138 may be generated based upon the second interference representational mode (e.g., the object 138 may be generated to have the second visual attribute indicated by the second interference representational mode) based upon a determination that each of the interference metrics associated with the regions D-6, D-7, E-6 and E-7 is within the second range of interference metrics. In an example, the first visual attribute may be indicative of a yellow color (or a different color) and/or the second visual attribute may be indicative of a red color (or a different color).

In some examples, the interference map 116 may be displayed via the GUI 110. In some examples, the interference map 116 may be interactive. For example, in response to a selection of a region of the set of regions and/or an object of the set of objects, an interference metric associated with the object may be displayed. For example, in response to receiving a selection of the object 132 (and/or a selection of the region H-2) via the GUI 110, the indication of the interference metric (of the set of interference metrics 114) associated with the region H-2 may be displayed via the GUI 110.

At 208 of FIG. 2, one or more corrective actions may be performed (by the computer 108, the interference agent and/or a robot, for example) based upon the interference map 116. The one or more corrective actions may be associated with the first wireless communication site of the set of networking components. For example, the one or more corrective actions may include evaluating the interference map 116 to identify a potential interference source (e.g., at least one of a faulty radio, a faulty cable, a faulty connector, a rusted component, machinery, an HVAC unit, parapet wall, metallic bird spike, etc.). In some examples, the potential interference source may be in a vicinity of the first wireless communication site. In some examples, the one or more corrective actions may include ordering deeper inspection of one or more regions (e.g., regions H-2, G-3, F-4, E-6, E-7, D-6 and/or D-7) to identify the potential interference source (and/or one or more other potential interference sources). The one or more corrective actions may include performing one or more interference mitigation actions to mitigate (e.g., at least one of block, prevent, reduce, inhibit, etc.) interference of the potential interference source with the first wireless communication site.

In some examples, the one or more interference mitigation actions may include one or more adjustments (e.g., automatic adjustments) associated with the first wireless communication site. In an example, the computer 108 (and/or a different computer) may transmit an instruction to perform the one or more adjustments to the first wireless communication site, a site controller configured to control operation of the first wireless communication site and/or a robot. The one or more adjustments may include (i) adjusting (e.g., decreasing or increasing) a transmission power associated with the first wireless communication site (e.g., switching from using a first transmission power to transmit signals to using a second transmission power to transmit signals), (ii) adjusting a frequency channel associated with the wireless communication site (e.g., switching from using a first frequency channel to transmit signals to using a second frequency channel to transmit signals), (iii) adjusting an antenna tilt associated with an antenna of the wireless communication site (e.g., the antenna may be moved and/or tilted using the robot), (iv) adjusting an azimuth associated with the antenna, and/or (v) adjusting an antenna height associated with the antenna. Performing the one or more adjustments may mitigate interference from the potential interference source impacting service provided by the first wireless communication site.

In some examples, the one or more interference mitigation actions may include repairing and/or replacing (by the interference agent and/or a robot, for example) one or more components of the potential interference source (e.g., repairing and/or replacing at least one of faulty radios, faulty cables, faulty connectors, rusted parts, etc.). The one or more interference mitigation actions may include moving (by the interference agent and/or a robot, for example) the potential interference source (e.g., at least one of machinery, an HVAC unit, parapet wall, metallic bird spike, etc.) to a different location. For example, the different location may be far enough from the first wireless communication site such that interference from the potential interference source does not impact the first wireless communication site. The one or more interference mitigation actions may include placing (by the interference agent and/or a robot, for example) an interference mitigation structure in a position relative to the potential interference source. For example, the interference mitigation structure may comprise at least one of a wall, a tarp, etc. The interference mitigation structure may be placed between the potential interference source and the first wireless communication site to mitigate (e.g., block and/or reduce) RF signals emitted by the potential interference source reaching and/or interfering with the first wireless communication site. In some examples, performing the one or more corrective actions may resolve the network performance issue.

In some examples, the system 101 may be used for real-time troubleshooting. After performing the one or more corrective actions, a second interference map may be generated (using one or more of the techniques provided herein with respect to generating the interference map 116, for example). The second interference map may be associated with the view depicted by the image 112. The second interference map may be compared with the interference map 116 to determine an effectiveness of the one or more corrective actions and/or to determine whether to perform one or more further corrective actions.

In some examples, a plurality of interference maps (e.g., the interference map 116, the second interference map, and/or one or more other interference maps) associated with the view depicted in the image 112 may be generated using the techniques provided herein. The plurality of interference maps may be generated at different times. The plurality of interference maps may be used to monitor interference associated with the set of networking components throughout the different times. In some examples, one some and/or all interference maps of the plurality of interference maps may be generated automatically. In some examples, the computer 108 may evaluate the plurality of interference maps to determine whether interference conditions associated with the set of networking components are worsening over time. In some examples, an alert (e.g., an email, a text message, etc.) may be transmitted to one or more client devices (e.g., a client device associated with the interference agent) in response to determining that interference conditions associated with the set of networking components are worsening over time.

In some examples, one, some and/or all components of the system 101 (e.g., the antenna 102, the camera 104, the computer 108, the motor 106, and/or a display screen displaying the GUI 110) are disposed in a housing 160 (shown in FIG. 1G). In some examples, the housing 160 includes a portable power source (e.g., a rechargeable battery) to power the system 101.

FIG. 1G illustrates a calibration process associated with the system 101, according to some embodiments. The calibration process may be performed to calibrate a position of the antenna 102 relative to the camera 104. In some examples, the calibration process may be performed periodically (e.g., once per week, once per month, etc.) and/or in an aperiodic manner. In some examples, the calibration process may include positioning the housing 160 (and/or the antenna 102 and/or the camera 104) in a position facing a calibration panel 150 which has one or more visual markings (e.g., a visual grid and/or markings 152 that are spaced apart from each other at predefined intervals). In an example, the calibration panel 150 may correspond to at least one of a wall, a piece of vinyl, a tarp, a board, a poster, etc. Alternatively and/or additionally, the calibration process may include using a laser pointer 162 (that is coupled to the antenna 102, for example) to emit a laser beam 164 to the calibration panel 150. In some examples, the laser pointer 162 and the antenna 102 are calibrated to be accurate (for receive direction, for example) and/or may be mechanically fixed with respect to each other. Alternatively and/or additionally, the calibration process may include using the camera 104 to capture a calibration image of the laser beam 164 being emitted onto the calibration panel 150. Alternatively and/or additionally, the calibration process may include evaluating the calibration image to compare a position of the laser beam 164 on the calibration panel 150 to a visual marking of the one or more visual markings (e.g., a portion of the visual grid and/or a marking 152). Alternatively and/or additionally, the calibration process may include calibrating the position of the antenna 102 relative to the camera 104 based upon the comparison of the position of the laser beam 164 on the calibration panel 150 to the visual marking.

FIG. 1H illustrates an example gain pattern representation 170 of the antenna 102, according to some embodiments. In some examples, the antenna 102 may comprise a directional antenna (e.g., a beam antenna, such as a narrow beam antenna). In some examples, the system 101 may comprise a screen 172 defining an aperture 174. The screen 172 may be positioned relative to the antenna 102 to have an impact on the example gain pattern representation 170. In some examples, one or more primary RF signals associated with an RF signal reading of a region (e.g., the first region) of the set of regions being performed by the antenna 102, such as primary RF signal 176, may be conducted through the aperture 174 defined by the screen 172 to the antenna 102. The one or more primary RF signals may be sensed and/or measured by the antenna 102 to determine an interference metric associated with the region (e.g., the first interference metric associated with the first region).

In some examples, the screen 172 comprises an RF signal-reflective material and/or an RF signal-absorbent material. The screen 172 may mitigate (e.g., block and/or inhibit) one or more non-primary RF signals, such as non-primary RF signals 178 and 180, reaching the antenna 102. In some examples, the one or more primary RF signals may be associated with (e.g., may originate from) the region being measured. In some examples, the one or more non-primary RF signals may not be associated with (and/or may not originate from) the region being measured. Thus, mitigating the one or more non-primary RF signals and/or conducting the one or more primary RF signals to the antenna 102 may provide for increased accuracy of the interference metric (e.g., the first interference metric) being determined for the region (e.g., the first region).

In some examples, an aperture size 175 associated with the aperture 174 is adjustable (e.g., automatically adjustable). In some examples, the aperture size 175 may be increased to increase a wavelength of a target RF signal being measured. Alternatively and/or additionally, the aperture size 175 may be decreased to decrease a wavelength of a target RF signal being measured. In some examples, the aperture size 175 may be configured such that a target RF signal (e.g., the primary RF signal 176) measured by the antenna 102 has a wavelength between about 700 megahertz to about 2,100 megahertz.

In some examples, the image 112 may comprise a first video frame of a video captured using the camera 104. In some examples, the video may comprise a real-time video (and/or near real-time video) captured using the camera 104. In some examples, while the video is being recorded, the system 101 may automatically scan video frames of the video to generate interference maps associated with the video frames, such as using one or more of the techniques provided herein for generating the interference map 116 based upon the image 112. The GUI 110 may display a real-time interference map representative of interference associated with the video (while the video is being captured, for example). For example, in response to the first video frame of the video being captured by the camera 104, the interference map 116 may be generated based upon the first video frame and/or the GUI 110 may display the interference map 116. In response to a second video frame (after the first video frame) of the video being captured by the camera 104, a third interference map may be generated based upon the second video frame (using one or more of the techniques provided herein for generating the interference map 116 based upon the image 112, for example), and/or the GUI 110 may display the third interference map.

In some examples, the set of interference metrics 114 may comprise passive intermodulation (PIM) interference metrics (e.g., each interference metric of one, some and/or all of the set of interference metrics 114 may be a PIM interference metric). In some examples, interference, as used in the present disclosure, may refer to PIM interference or a combination of two or more types of interference comprising PIM interference. The interference map 116 may correspond to a PIM interference map.

Implementation of at least some of the disclosed subject matter may lead to benefits including, but not limited to, reduced (and/or zero) manual effort in comparison with some interference inspection techniques that rely on one or more people to manually areas around wireless communication sites for sources of interference.

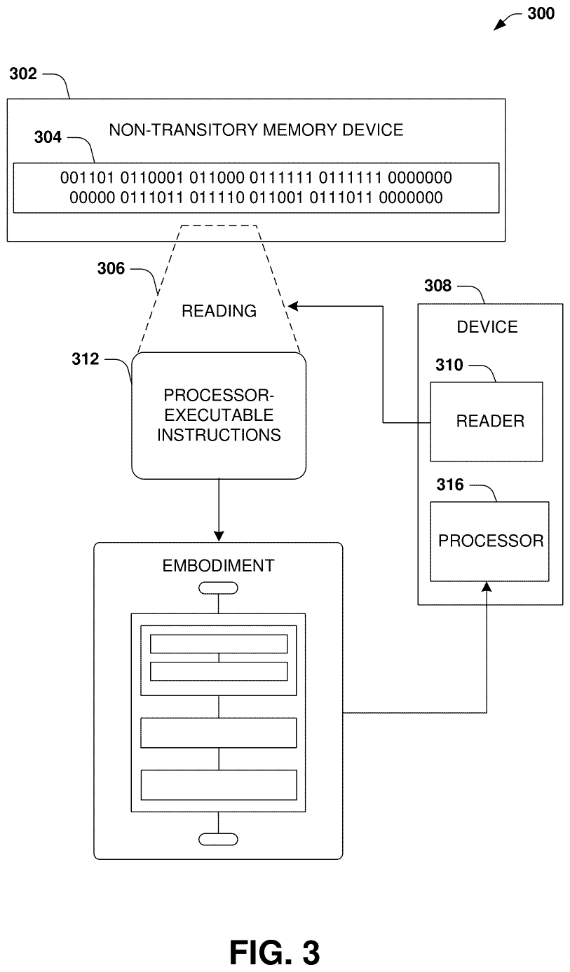

FIG. 3 is an illustration of a scenario 300 involving an example non-transitory machine readable medium 302. The non-transitory machine readable medium 302 may comprise processor-executable instructions 312 that when executed by a processor 316 cause performance (e.g., by the processor 316) of at least some of the provisions herein. The non-transitory machine readable medium 302 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 302 stores computer-readable data 304 that, when subjected to reading 306 by a reader 310 of a device 308 (e.g., a read head of a hard disk drive, or a read operation invoked on a solid-state storage device), express the processor-executable instructions 312. In some embodiments, the processor-executable instructions 312, when executed cause performance of operations, such as at least some of the example method 200 of FIG. 2, for example. In some embodiments, the processor-executable instructions 312 are configured to cause implementation of a system, such as at least some of the example system 101 of FIGS. 1A-1H, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
receiving an image of a view;
determining, using an antenna, one or more interference metrics associated with one or more regions of the view;
generating an interference map associated with the view based upon the image and the one or more interference metrics; and
performing, based upon the interference map, one or more corrective actions associated with a wireless communication site.

2. The method of claim 1, wherein the one or more corrective actions comprise:
evaluating the interference map to identify a potential interference source; and
performing one or more interference mitigation actions to mitigate interference of the potential interference source with the wireless communication site.

3. The method of claim 2, wherein the one more interference mitigation actions comprise at least one of:
adjusting a transmission power associated with the wireless communication site;
adjusting a frequency channel associated with the wireless communication site;
adjusting an antenna tilt associated with an antenna of the wireless communication site;
adjusting an azimuth associated with the antenna; or
adjusting an antenna height associated with the antenna.

4. The method of claim 2, wherein the one more interference mitigation actions comprise at least one of:
at least one of replacing or repairing one or more components of the potential interference source;
moving the potential interference source to a different location; or
placing an interference mitigation structure in a position relative to the potential interference source.

5. The method of claim 1, wherein:
the determining the one or more interference metrics comprises:
determining a first interference metric associated with a first region;
determining a second interference metric associated with a second region; and
the generating the interference map comprises:
generating a first section of the interference map based upon the first interference metric and a first section of the image; and
generating a second section of the interference map based upon the second interference metric and a second section of the image.

6. The method of claim 5, comprising:
after determining the first interference metric and before determining the second interference metric, moving the antenna from a first position associated with measuring interference associated with the first region to a second position associated with measuring interference associated with the second region, wherein the second interference metric is based upon one or more radio frequency (RF) signal readings performed by the antenna while the antenna is in the second position.

7. The method of claim 6, wherein:
the moving the antenna from the first position to the second position is performed using a motor coupled to the antenna.

8. The method of claim 1, wherein:
the determining the one or more interference metrics comprises:
determining a first interference metric associated with a first region of the view; and
determining a second interference metric associated with a second region of the view; and wherein
the generating the interference map comprises:
determining a first visual attribute based upon the first interference metric;
determining a second visual attribute based upon the second interference metric;
overlaying a first object having the first visual attribute onto a first section of the image to generate a first section of the interference map; and
overlaying a second object having the second visual attribute onto a second section of the image to generate a second section of the interference map.

9. The method of claim 8, wherein at least one of:
the first object is transparent to provide visibility of the first section of the image through the first object; or
the second object is transparent to provide visibility of the second section of the image through the second object.

10. The method of claim 1, comprising:
displaying the interference map via a graphical user interface.

11. The method of claim 10, wherein the determining the one or more interference metrics comprises determining a first interference metric associated with a first region of the view, the method comprising:
receiving, via the graphical user interface, a selection of the first region; and
in response to the selection, displaying an indication of the first interference metric via the graphical user interface.

12. The method of claim 1, wherein:
the one or more interference metrics comprise one or more passive intermodulation (PIM) interference metrics.

13. A system comprising:
a camera configured to capture an image of a view;
an antenna configured to determine one or more interference metrics associated with one or more regions of the view; and
a computer configured to generate an interference map associated with the view based upon the image and the one or more interference metrics.

14. The system of claim 13, wherein:
the one or more interference metrics comprise:
a first interference metric associated with a first region of the view; and
a second interference metric associated with a second region of the view; and
the computer is configured to:
generate a first section of the interference map based upon the first interference metric and a first section of the image; and
generate a second section of the interference map based upon the second interference metric and a second section of the image.

15. The system of claim 14, comprising:
a motor configured to move, after the first interference metric is determined and before the second interference metric is determined, the antenna from a first position associated with measuring interference associated with the first region to a second position associated with measuring interference associated with the second region, wherein the second interference metric is based upon one or more radio frequency (RF) signal readings performed by the antenna while the antenna is in the second position.

16. The system of claim 13, wherein:
the one or more interference metrics comprise one or more passive intermodulation (PIM) metrics.

17. A device, comprising:
a processor configured to execute instructions to perform operations comprising:
receiving an image of a view;
determining, using an antenna, one or more interference metrics associated with one or more regions of the view; and
generating an interference map associated with the view based upon the image and the one or more interference metrics.

18. The device of claim 17, wherein:
the determining the one or more interference metrics comprises:
determining a first interference metric associated with a first region of the view; and
determining a second interference metric associated with a second region of the view; and
the generating the interference map comprises:
generating a first section of the interference map based upon the first interference metric and a first section of the image; and
generating a second section of the interference map based upon the second interference metric and a second section of the image.

19. The device of claim 18, the operations comprising:
after determining the first interference metric and before determining the second interference metric, moving the antenna from a first position associated with measuring interference associated with the first region to a second position associated with measuring interference associated with the second region, wherein the second interference metric is based upon one or more radio frequency (RF) signal readings performed by the antenna while the antenna is in the second position.

20. The device of claim 19, wherein:
moving the antenna from the first position to the second position is performed using a motor coupled to the antenna.
